(19) United States
(12) Patent Application Publication
(10) Pub. No.: US 2023/0348234 A1
(43) Pub. Date: Nov. 2, 2023

(54) PRESSING AND STRETCHING STRUCTURE AND CLAMPING STRUCTURE OF CONTAINER SPREADER

(71) Applicant: Southwest Jiaotong University, Chengdu (CN)

(72) Inventors: Zeqiang ZHANG, Chengdu (CN); Yanqing ZENG, Chengdu (CN); Hongbin ZHENG, Chengdu (CN); Silu LIU, Chengdu (CN); Tengfei WU, Chengdu (CN); Wenming CHENG, Chengdu (CN)

(21) Appl. No.: 17/886,484

(22) Filed: Aug. 12, 2022

(30) Foreign Application Priority Data
Apr. 27, 2022 (CN) 202210457965.8

(51) Int. Cl. B66C 1/66; B66C 1/10

(52) U.S. Cl. CPC B66C 1/663; B66C 1/101

(57) ABSTRACT

The present invention discloses a pressing and stretching structure and a clamping structure of a container spreader, and belongs to the technical field of crane accessories. The pressing and stretching structure comprises a telescopic rod, a rotating mechanism and a guiding cylinder which is arranged vertically; a radially telescopic pin is arranged in the guiding cylinder and stoppers are arranged at a lower end; a first annular lug boss and a second annular lug boss are arranged at an interval from top to bottom on an outer wall of the telescopic rod; a sliding bush is sleeved between the first lug boss and the second lug boss; and the rotating mechanism is used for making the telescopic rod and the guiding cylinder to move relatively so that the limiting rod on the telescopic rod reaches the positions of the lower end surface and the upper end surface of the stoppers.

### TECHNICAL FIELD

The present invention relates to the technical field of crane accessories, also relates to the technical field of stretching equipment, and particularly relates to a pressing and stretching structure and a clamping structure of a container spreader.

### BACKGROUND

A container spender is important equipment for transferring containers in short distance, and is common in docks, wherein a clamping device is an important part of the container spreader. The spreader uses the grabbing and unloading actions of the clamping device to extract and unload containers. Generally, the clamping device needs to be matched with independent power equipment to drive the clamping device to achieve the actions of grasping and unloading the containers. For example, Chinese application patent CN201821322886.1 discloses a grab structure of a crane for a container, which needs to use an electric telescopic rod to complete the movement of a locking device. Thus, the grab structure needs to be provided with related accessories such as a motor and a cable. The overall mass of the grab structure is large, and energy consumption in the process of lifting the container is also high. In this case, Chinese patent CN202011219826.9 discloses a clamping device for non-driven adaptive grabbing and unloading of containers, which skillfully uses the pressing and stretching structure to achieve the clamping and unloading of containers, without the need for matching power equipment to drive the grab to stretch; and the pressing and stretching structure is the conventional ballpoint pen stretching structure.

### SUMMARY

To solve the above at least one problem, the present invention provides a new pressing and stretching structure, and also provides a new mode to realize non-driven adaptive clamping of container spreaders. The solution of the present invention is as follows:

A pressing and stretching structure comprises a telescopic rod, a rotating mechanism and a guiding cylinder which is arranged vertically; the middle of the guiding cylinder is provided with a pin which can be stretched radially inwards along the guiding cylinder; the lower part of the guiding cylinder is provided with two or more stoppers extending down axially, and the stoppers are arranged at intervals; the telescopic rod is arranged coaxially with the guiding cylinder and can move along the axial direction of the guiding cylinder; a first annular lug boss and a second annular lug boss are arranged at an interval from top to bottom on an outer wall of the telescopic rod; the outer wall of the telescopic rod between the first lug boss and the second lug boss is sleeved with a sliding bush; the sliding bush can move between the first lug boss and the second lug boss along the telescopic rod; when the sliding bush comes into contact with the second lug boss, an annular groove is formed between the upper end surface of the sliding bush and the lower end surface of the first lug boss; the outer wall of the second lug boss is provided with a limiting rod which extends outwards radially; the limiting rod comes into contact with the stoppers or enters a gap between the stoppers to limit the upward movement of the telescopic rod; overall sizes of the pin, the first lug boss and the sliding bush are matched; in the process that the telescopic rod moves up along the guiding cylinder to the limiting rod to reach the upper end surface of the stopper, the pin can slide along the first lug boss and the outer wall of the sliding bush until the pin comes into contact with the circumferential side wall of the sliding bush or the pin is located below the sliding bush; a frictional force between the pin and the circumferential side wall of the sliding bush is greater than a resultant force of a frictional force between the sliding bush and the telescopic rod and the gravity of the sliding bush; in the process that the telescopic rod moves down along the guiding cylinder, after the pin comes into contact with the outer wall of the sliding bush, the sliding bush can be driven to move axially relative to the telescopic rod to make the sliding bush come into contact with the first lug boss; the upper end surface of the sliding bush is matched with the lower end surface of the first lug boss so that the pin can move to the circumferential side wall of the first lug boss along the outer wall of the sliding bush and the telescopic rod can continue to move down along the guiding cylinder; in the process that the telescopic rod moves up along the guiding cylinder, when the limiting rod reaches the lower end surface of the stopper, the pin is located in the annular groove and can be matched with the lower end surface of the first lug boss to prevent the downward movement of the telescopic rod; the rotating mechanism is used for making the telescopic rod and the guiding cylinder to move relatively so that the limiting rod reaches the positions of the lower end surface and the upper end surface of the stoppers periodically.

For the present invention, the rotating mechanism can adopt the existing way, such as a common switch pen. The present invention also provides a specific implementation form. The rotating mechanism comprises a plurality of longitudinally extending longitudinal grooves located above the pin and on the inner wall of the guiding cylinder, and a guiding rod located above the first lug boss and in the telescopic rod and capable of stretching and contracting radially and pressing the inner wall of the guiding cylinder; two adjacent longitudinal grooves are communicated by a linear inclined groove, and one end of the guiding rod extends into and moves along the longitudinal grooves or inclined grooves; the depth of each notch of the longitudinal grooves or inclined grooves is configured so that the guiding rod can move from a longitudinal groove to an adjacent longitudinal groove along the inclined groove in a stage of a process that the telescopic rod moves up or down along the guiding cylinder; and when the limiting rod reaches the lower end surface of the stopper, the guiding rod is located above the inclined groove. When the guiding rod is located in one longitudinal groove, the limiting rod directly faces one of a gap between the stoppers and the lower end surface of the stoppers; and when the guiding rod is located in an adjacent longitudinal groove, the limiting rod directly faces the other one of the gap between the stoppers and the lower end surface of the stoppers. There are many ways for configuring the depth of each notch of the longitudinal grooves or inclined grooves. For example, the longitudinal groove comprises A section, B section and C section which are connected in sequence from top to bottom, wherein an outlet of one inclined groove is communicated with a joint between A section and B section, and the notch depth of the outlet of the inclined groove is less than the notch depth of the joint between A section and B section so that the guiding rod can move along the longitudinal groove after entering the longitudinal groove; an inlet of another inclined groove is communicated with a joint between B section and C section; and the notch depth of C section at the joint between B section and C section is greater than the notch depth of B section, and the notch depth of C section is not greater than the notch depth of the inlet of another inclined groove so that the guiding rod enters the inclined groove when moving up along C section.

In addition, the telescopic rod of the present invention can move down along the guiding cylinder depending on the own gravity. Of course, an elastic component can also be arranged, and the elastic component can be used to push the telescopic rod to move down along the axial direction of the guiding cylinder. The main purpose is to prevent the telescopic rod from being difficult to successfully move down due to gravity insufficiency.

A clamping structure of a container spreader comprises a pressing and stretching device, a push-pull rod and a supporting rod. Both ends of the supporting rod are hinged with hooks for grasping containers; the supporting rod is a hollow structure, and the push-pull rod is arranged in a cavity of the supporting rod along an extension direction of the supporting rod; the push-pull rod is slidably connected with the supporting rod; the pressing and stretching device comprises a pressing part located at the bottom of the supporting rod, triggers own periodic stretching and contraction by pressing the pressing part and then drives the push-pull rod to move back and forth along the supporting rod; when the push-pull rod moves back and forth along the supporting rod, the hook is driven to make reciprocating actions of grabbing and unloading containers; after the containers are mounted by the hook, the effective pressing operation space of the pressing part is located above the containers, so that the containers can press the pressing part again to trigger own stretching, wherein the pressing and stretching device uses the pressing and stretching structure in the above solution; the guiding cylinder is fixedly connected with the supporting rod; the outer wall of the telescopic rod of the pressing and stretching structure is also provided with a third lug boss which extends radially outwards; a hinged disc is sleeved between the third lug boss and the second lug boss; the hinged disc can rotate along the telescopic rod, and is hinged with the push-pull rod through a hinging rod to convert the stretching and contraction actions of the telescopic rod into the grabbing and unloading actions of the hook; and the pressing part is located at the bottom of the telescopic rod.

Compared with the prior art, the present invention provides a new structure to realize pressing and stretching actions, and provides a new realization mode for non-driven adaptive clamping of container spreaders.

### DESCRIPTION OF DRAWINGS

FIG. 1 is a sectional view of a pressing and stretching structure;

FIG. 2 is a sectional view of a guiding cylinder;

FIG. 3 is a front view of FIG. 2;

FIG. 4 is a sectional view of a telescopic rod;

FIG. 5 is a schematic diagram of overall size fit of a pin, a first lug boss and a sliding bush;

FIG. 6 is a three-dimensional structural schematic diagram of a champing structure of a container spreader; and

FIG. 7 is a local sectional view of FIG. 6.

In the figures, 1 guiding cylinder; 2 telescopic rod; 3 pin; 4 sliding bush; 5 longitudinal groove; 6 inclined groove;
7 guiding rod; 8 hinged disc; 9 hinging rod; 10 push-pull rod; 11 connecting rod; 12 supporting rod; 13 hook;
14 push-pull rod; 21 pressing part;
101 guiding hole; 102 accommodating hole; 103 stopper; 104 notch;
201 first lug boss; 202 second lug boss; 203 third lug boss;
501 A section; 502 B section; 503 C section;
1031 stopper upper end surface; 1032 stopper lower end surface;
2021 limiting rod.

### DETAILED DESCRIPTION

The present invention will be further described below in detail in combination with embodiments and drawings, but the implementation modes of the present invention are limited thereto.

It should be indicated in the description of the present invention that terms such as “upper”, “lower”, “front”, “rear”, “left”, “right”, “top”, “bottom”, “inner”, “outer”, etc. indicate direction or position relationships shown based on the drawings, and are only intended to facilitate the description of the present invention and the simplification of the description rather than to indicate or imply that the indicated device or element must have a specific direction or constructed and operated in a specific direction, and therefore, shall not be understood as a limitation to the present invention.

### Embodiment 1

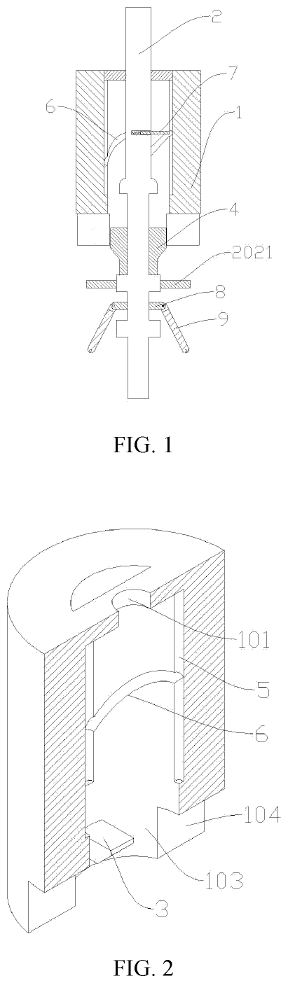

With reference to FIG. 1, FIG. 1 is a sectional view of a pressing and stretching structure. The pressing and stretching structure comprises a telescopic rod 2, a rotating mechanism and a guiding cylinder 1 which is arranged vertically. The telescopic rod 2 is arranged coaxially with the guiding cylinder 1 and can move along the axial direction of the guiding cylinder 1 to realize stretching and contraction.

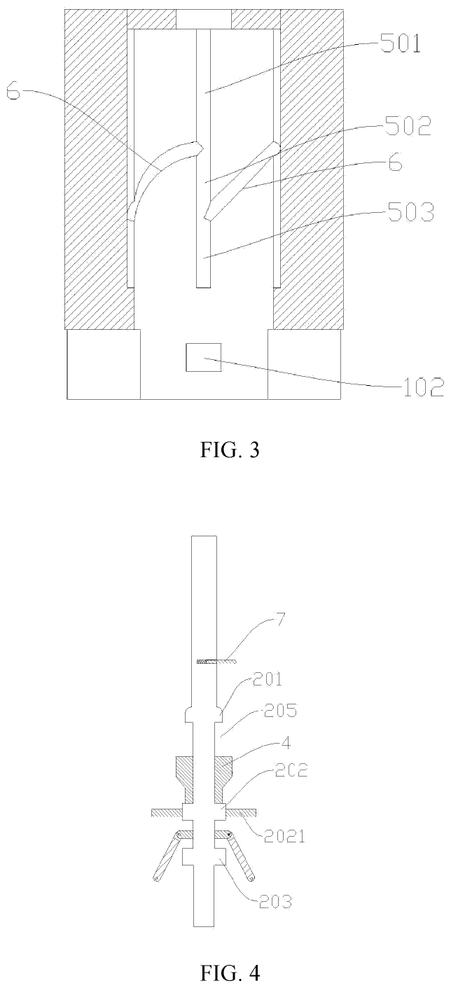

With reference to FIG. 2 and FIG. 3, FIG. 2 is a sectional view of the guiding cylinder and FIG. 3 is a front view of FIG. 2. A guiding hole 101 is arranged at the top of the guiding cylinder 1 and is used for guiding the telescopic rod 2 to move along the axial direction of the guiding cylinder 1. An accommodating hole 102 which extends along the radial direction of the guiding cylinder 1 is arranged in the middle of the guiding cylinder 1; a pin 3 is slidably arranged in the accommodating hole 102; and the pin 3 can stretch inwards along the radial direction of the guiding cylinder 1 to press the outer wall of the telescopic rod 2. There are many specific ways to realize stretching, and for example, a spring (not shown in the figure) is arranged to push the pin 3 to inwards move radially to press the outer wall of the telescopic rod 2. The lower end of the guiding cylinder 1 is provided with two stoppers 103 which extend down axially; the two stoppers 103 are arranged at an interval; and a concave notch 104 is formed between the stoppers.

By further combining with FIG. 1 and FIG. 4, FIG. 4 is a sectional view of the telescopic rod. One end of the telescopic rod 2 penetrates through the guiding hole 101 so that the telescopic rod can move along the axial direction of the guiding cylinder 1. A first annular lug boss 201, a second annular lug boss 202, and a third annular lug boss 203 are arranged at intervals from top to bottom on the outer wall of the telescopic rod 2. The outer wall of the telescopic rod 2 between the first lug boss 201 and the second lug boss 203 is sleeved with a sliding bush 4; and the sliding bush 4 can move between the first lug boss 201 and the second lug boss 203 along the telescopic rod 1. When the lower end surface of the sliding bush 4 comes into contact with the upper end surface of the second lug boss 203, an annular groove 205 is formed between the upper end surface of the sliding bush 4 and the lower end surface of the first lug boss 201; the outer wall of the second lug boss 202 is provided with a limiting rod 2021 which extends outwards radially; and the limiting rod 2021 is used for limiting the height of upward movement of the telescopic rod 2 along the axial direction of the guiding cylinder 1. There are two situations in which an angle between the limiting rod 2021 and the notch 201 is different when the telescopic rod 2 moves up along the axial direction of the guiding cylinder 1. One situation is that the limiting rod 2021 comes into contact with a stopper lower end surface 1032; and the other situation is that the limiting rod 2021 enters the notch 104 and moves further up to the top of the stopper 103. Of course, the highest upward movement positions of the telescopic rod 2 are different in the two situations, wherein the position of the telescopic rod 1 is higher when the stopper 103 enters the notch 104 and is limited.

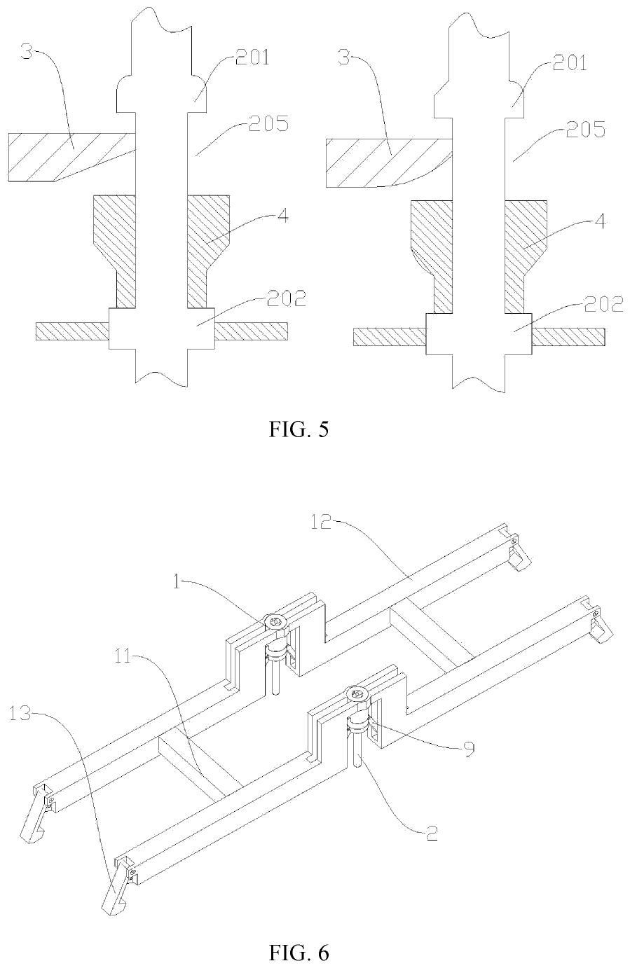

Overall sizes of the pin 3, the first lug boss 201 and the sliding bush 4 are matched; in the process that the telescopic rod 2 moves up along the guiding cylinder 1 to the limiting rod 2021 to reach a stopper upper end surface 1031, the pin 3 can slide along the first lug boss 201 and the outer wall of the sliding bush 4 until the pin 3 comes into contact with the circumferential side wall of the sliding bush 4 or the pin is located below the sliding bush 4 so that the pin 3 can come into contact with the circumferential side wall of the sliding bush 4 when the telescopic rod 2 moves down along the guiding cylinder 1. There are many specific matching ways for the overall sizes of the pin 3, the first lug boss 201 and the sliding bush 4. For example, the upper end surface of the first lug boss 201 is a curved surface, the lower end surface of the pin 3 is a curved surface and the upper end surface of the sliding bush is a curved surface. Various feasible matching modes are provided in FIG. 5. A frictional force between the pin 3 and the circumferential side wall of the sliding bush 4 is greater than a resultant force of a frictional force between the sliding bush 4 and the telescopic rod 1 and the gravity of the sliding bush 4. Therefore, in the process that the telescopic rod 2 moves down along the guiding cylinder 1, after the pin 3 comes into contact with the outer wall of the sliding bush 4, the sliding bush 4 can be driven to move axially relative to the telescopic rod 2 to make the sliding bush 4 come into contact with the first lug boss 201; and the upper end surface of the sliding bush 4 is matched with the lower end surface of the first lug boss 201 so that the pin 3 can move to the circumferential side wall of the first lug boss 201 along the outer wall of the sliding bush 4 to avoid blocking the telescopic rod 2 from moving down due to the contact with the lower end surface of the first lug boss 201, so that the telescopic rod 2 can continue to move down along the guiding cylinder 1. Here, there are many matching modes for the upper end surface of the sliding bush 4 and the lower end surface of the first lug boss 201. For example, the size of the upper end surface of the sliding bush is greater than the size of the lower end surface of the first lug boss 201, and after fitting, the two are in seamless connection. In addition, other implementation modes are also provided in FIG. 5.

In the process that the telescopic rod 2 moves up along the guiding cylinder 1, when the limiting rod 2021 reaches the stopper lower end surface 1032, the pin 3 is located in the annular groove 205 and can be matched with the lower end surface of the first lug boss 201 to prevent the downward movement of the telescopic rod 2.

The rotating mechanism is used for making the telescopic rod 2 and the guiding cylinder 1 to move relatively so that the limiting rod 2021 makes contact and limiting periodically with the stopper lower end surface 1032 and the notch 104 between the stoppers 103.

With reference to FIG. 1 and FIG. 3, the inner wall of the guiding cylinder 1 located above the pin 3 is uniformly provided with four longitudinally extending longitudinal grooves 5; two adjacent longitudinal grooves 5 are communicated by a linear inclined groove 6; the outlet position of the inclined groove 6 is higher than the inlet position; a guiding rod 7 is radially arranged in the telescopic rod 1 located above the first lug boss 201; one end of the guiding rod 7 extends into and moves along the longitudinal grooves 5 or inclined grooves 6; the guiding rod 7 adopts telescopic setting to press the inner wall of the guiding cylinder 1; the depth of each notch of the longitudinal grooves 5 or inclined grooves 6 is configured so that the guiding rod 7 can move from a longitudinal groove 5 to an adjacent longitudinal groove 5 along the inclined groove 6 in a stage of a process that the telescopic rod 1 moves up or down. For example, the longitudinal groove 5 comprises A section 501, B section 502 and C section 503 which are connected in sequence from top to bottom, wherein an outlet of one inclined groove 6 is communicated with a joint between A section 501 and B section 502, and the notch depth of the outlet of the inclined groove 6 is less than the notch depth of the joint between A section 501 and B section 502 so that the guiding rod 7 can move along the longitudinal groove 5 after entering the longitudinal groove 5 and may not return to the outlet of the inclined groove 6; an inlet of another inclined groove 6 is communicated with a joint between B section 502 and C section 503; and the notch depth of C section 503 at the joint between B section 502 and C section 503 is greater than the notch depth of B section 502, and the notch depth of C section 503 is not greater than the notch depth of the inlet of another inclined groove 6 so that the guiding rod 7 enters the inclined groove 6 when moving up along C section 503. Thus, when the telescopic rod 7 moves up, the telescopic rod 2 rotates by 90° relative to the guiding cylinder 1. Of course, to ensure that the telescopic rod 2 can rotate by 90° along the guiding cylinder 1 after the telescopic rod 2 moves up each time, when the limiting rod 2021 comes into contact with the stopper lower end surface 1032, the guiding rod 7 is located in A section 503.

In addition, the outer wall of the telescopic rod 2 located between the second lug boss 202 and the third lug boss 203 is sleeved with a hinged disc 8; the hinged disc 8 and the telescopic rod 2 are in intermittent fit so that the two can rotate relative to each other; hinging rods 9 are symmetrically arranged on both sides of the hinged disc 8.

In the present embodiment, when the limiting rod 2021 comes into contact with the stopper lower end surface 1032, the pin 3 is located in the annular groove 205. At this moment, if the telescopic rod 2 moves down, then the downward movement of the telescopic rod 2 is limited after the pin 3 comes into contact with the first lug boss 201. At this moment, the telescopic rod is in a first position; and when the telescopic rod 2 moves down again after the limiting rod 2021 enters the notch 104 and reaches the stopper upper end surface 1031, the telescopic rod can reach a second position below the first position to achieve that the telescopic rod stretches and contracts back and forth in the first position and the second position.

### Embodiment 2

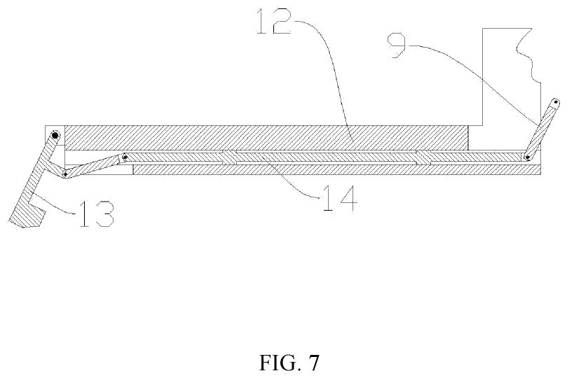

With reference to FIG. 6 and FIG. 7, FIG. 6 is a three-dimensional structural schematic diagram of a champing structure of a container spreader, and FIG. 7 is a local sectional view of FIG. 6. A clamping structure of a container spreader comprises a pressing and stretching structure, a push-pull rod 10, a connecting rod 11 and two supporting rods 12. The two supporting rods 12 are arranged in parallel and connected by the connecting rod 11. Both ends of the supporting rods 11 are hinged with hooks 13 for grasping containers (not shown in the figure); each supporting rod 12 is a hollow structure, and the push-pull rod 14 is arranged in a cavity of the supporting rod along an extension direction of the supporting rod 12; the push-pull rod 14 is slidably connected with the supporting rod 12; the pressing and stretching structure comprises a pressing part 21 located at the bottom of the supporting rod 12, i.e., at the lower end of the telescopic rod 2, triggers own periodic stretching and contraction by pressing the pressing part 21 and then drives the push-pull rod 14 to move back and forth along the supporting rod 2; when the push-pull rod 14 moves back and forth along the supporting rod 12, the hook 13 is driven to make reciprocating actions of grabbing and unloading containers; and after the containers are mounted by the hook 13, the effective pressing operation space of the pressing part 21 is located above the containers, so that the containers can press the pressing part 21 again to trigger own stretching.

The pressing and stretching structure in the present embodiment uses the pressing and stretching structure of embodiment 1. The guiding cylinder 2 is fixed with the supporting rod 1; the other end of the hinging rod 9 is hinged with the push-pull rod 14 so that the stretching and contraction actions of the telescopic rod 2 are converted into the grabbing and unloading actions of the hook 13; and the pressing part 21 is located at the bottom of the telescopic rod 2. In the use process, the telescopic rod moves down depending on the own gravity and moves up depending on the touching between the pressing part and the top of the container.

The above only describes preferred concrete implementation of the present invention, but the protection scope of the present invention is not limited thereto. Any change or replacement contemplated easily by those skilled in the art familiar with the technical field within the technical scope disclosed by embodiments of the present invention shall be covered within the protection scope of the present invention. Therefore, the protection scope of the present invention should be determined by the protection scope of the claims.

1. A pressing and stretching structure, comprising
a guiding cylinder arranged vertically, wherein the middle of the guiding cylinder is provided with a pin which can be stretched radially inwards along the guiding cylinder; the lower part of the guiding cylinder is provided with two or more stoppers extending down axially, and the stoppers are arranged at intervals;
a telescopic rod, wherein the telescopic rod is arranged coaxially with the guiding cylinder and can move along the axial direction of the guiding cylinder; a first annular lug boss and a second annular lug boss are arranged at an interval from top to bottom on an outer wall of the telescopic rod; the outer wall of the telescopic rod between the first lug boss and the second lug boss is sleeved with a sliding bush; the sliding bush can move between the first lug boss and the second lug boss along the telescopic rod; when the sliding bush comes into contact with the second lug boss, an annular groove is formed between the upper end surface of the sliding bush and the lower end surface of the first lug boss; the outer wall of the second lug boss is provided with a limiting rod which extends outwards radially; the limiting rod comes into contact with the stoppers or enters a gap between the stoppers to limit the upward movement of the telescopic rod; overall sizes of the pin, the first lug boss and the sliding bush are matched; in the process that the telescopic rod moves up along the guiding cylinder to the limiting rod to reach the upper end surface of the stopper, the pin can slide along the first lug boss and the outer wall of the sliding bush until the pin comes into contact with the circumferential side wall of the sliding bush or the pin is located below the sliding bush; a frictional force between the pin and the circumferential side wall of the sliding bush is greater than a resultant force of a frictional force between the sliding bush and the telescopic rod and the gravity of the sliding bush; in the process that the telescopic rod moves down along the guiding cylinder, after the pin comes into contact with the outer wall of the sliding bush, the sliding bush can be driven to move axially relative to the telescopic rod to make the sliding bush come into contact with the first lug boss; the upper end surface of the sliding bush is matched with the lower end surface of the first lug boss so that the pin can move to the circumferential side wall of the first lug boss along the outer wall of the sliding bush and the telescopic rod can continue to move down along the guiding cylinder; in the process that the telescopic rod moves up along the guiding cylinder, when the limiting rod reaches the lower end surface of the stopper, the pin is located in the annular groove and can be matched with the lower end surface of the first lug boss to prevent the downward movement of the telescopic rod;
a rotating mechanism used for making the telescopic rod and the guiding cylinder to move relatively so that the limiting rod reaches the positions of the lower end surface and the upper end surface of the stoppers periodically.

2. The pressing and stretching structure according to claim 1, wherein the rotating mechanism comprises a plurality of longitudinally extending longitudinal grooves located above the pin and on the inner wall of the guiding cylinder, and a guiding rod located above the first lug boss and in the telescopic rod and capable of stretching and contracting radially and pressing the inner wall of the guiding cylinder; two adjacent longitudinal grooves are communicated by a linear inclined groove, and one end of the guiding rod extends into and moves along the longitudinal grooves or inclined grooves; the depth of each notch of the longitudinal grooves or inclined grooves is configured so that the guiding rod can move from a longitudinal groove to an adjacent longitudinal groove along the inclined groove in a stage of a process that the telescopic rod moves up or down along the guiding cylinder; and when the limiting rod reaches the lower end surface of the stopper, the guiding rod is located above the inclined groove.

3. The pressing and stretching structure according to claim 2, wherein the longitudinal groove comprises A section, B section and C section which are connected in sequence from top to bottom, wherein a joint between A section and B section is communicated with an outlet of one inclined groove, and the notch depth of the outlet of the inclined groove is less than the notch depth of the joint between A section and B section; an inlet of another inclined groove is communicated with a joint between B section and C section; and the notch depth of C section at the joint between B section and C section is greater than the notch depth of B section, and the notch depth of C section is not greater than the notch depth of the inlet of another inclined groove.

4. A clamping structure of a container spreader, comprising a pressing and stretching device, a push-pull rod and a supporting rod, wherein both ends of the supporting rod are hinged with hooks for grasping containers; the supporting rod is a hollow structure, and the push-pull rod is arranged in a cavity of the supporting rod along an extension direction of the supporting rod; the push-pull rod is slidably connected with the supporting rod; the pressing and stretching device comprises a pressing part located at the bottom of the supporting rod, triggers own periodic stretching and contraction by pressing the pressing part and then drives the push-pull rod to move back and forth along the supporting rod; when the push-pull rod moves back and forth along the supporting rod, the hook is driven to make reciprocating actions of grabbing and unloading containers; after the containers are mounted by the hook, the effective pressing operation space of the pressing part is located above the containers, so that the containers can press the pressing part again to trigger own stretching, wherein
the pressing and stretching device uses the pressing and stretching structure of claim 1; the guiding cylinder is fixedly connected with the supporting rod; the outer wall of the telescopic rod located below the second lug boss is also provided with a third lug boss which extends radially outwards; a hinged disc is sleeved between the third lug boss and the second lug boss; the hinged disc can rotate along the telescopic rod, and is hinged with the push-pull rod through a hinging rod to convert the stretching and contraction actions of the telescopic rod into the grabbing and unloading actions of the hook; and the pressing part is located at the bottom of the telescopic rod.
